(19) United States
(12) Patent Application Publication
(10) Pub. No.: US 2024/0405327 A1
(43) Pub. Date: Dec. 5, 2024

(54) BATTERY ASSEMBLY AND ASSEMBLING METHOD OF THE SAME

(71) Applicant: SK On Co., Ltd., Seoul (KR)

(72) Inventors: Chae Won NA, Daejeon (KR); Gang U LEE, Daejeon (KR); Won Gab HWANG, Daejeon (KR); Kyu Hyun HAN, Daejeon (KR)

(21) Appl. No.: 18/678,532

(22) Filed: May 30, 2024

(30) Foreign Application Priority Data
Jun. 2, 2023 (KR) 10-2023-0071690
Dec. 27, 2023 (KR) 10-2023-0192642

(51) Int. Cl. H01M 10/658; A62C 3/16; H01M 10/647; H01M 50/211; H01M 50/271

(52) U.S. Cl. CPC H01M 10/658; A62C 3/16; H01M 10/647; H01M 50/211; H01M 50/271; H01M 2200/10

(57) ABSTRACT

The present disclosure relates to a battery assembly including: a plurality of battery cells arranged in a preset stacking direction; an accommodating case accommodating the plurality of battery cells; an insertion space defined the plurality of battery cells and the accommodating case along the stacking direction; and an insertion member positioned in the insertion space, wherein the insertion member includes refractory particles; and a binder that binds the refractory particles to form a preset three-dimensional shape.

### CROSS-REFERENCE TO RELATED PATENT APPLICATION

The present application claims priority under 35 U.S.C. § 119 (a) to Korean patent application number 10-2023-0071690 filed on Jun. 2, 2023 and Korean patent application number 10-2023-0192642 filed on Dec. 27, 2023, in the Korean Intellectual Property Office, the entire disclosure of which is incorporated by reference herein.

### BACKGROUND OF THE INVENTION

### 1. Field

The present disclosure relates to a battery assembly and an assembling method of the same. Specifically, it relates to a battery assembly with improved stability and an assembling method of the same.

### 2. Description of the Related Art

Recently, due to fire or explosion accidents occurring during the use of lithium secondary batteries, social concerns about the safety of battery use are increasing. Based on these social concerns, one of the recent major developmental tasks of lithium secondary batteries is to eliminate instabilities such as fire and explosion caused by thermal runaway of battery cells.

In particular, empty spaces other than battery cells, which are energy sources, exist in the battery module/pack. When a fire occurs due to an external shock or a problem of a battery cell, a flame is transferred to an adjacent cell through an empty space, and damage caused by the fire may increase. Since this risk of fire may be the biggest obstacle in the electric vehicle market, the importance of research on a method or structure that can block or mitigate the propagation of fire is gradually increasing.

### SUMMARY OF THE INVENTION

First, according to one aspect of the present disclosure, a problem to solve is to prevent or mitigate the escape of a high-temperature gas or flame in the direction of a lead tab or tab of a battery cell where thermal runaway has occurred in a battery accommodated in a battery assembly (e.g., battery module).

Second, according to another aspect of the present disclosure, a problem to be solved is to vent a high-temperature gas generated from a battery cell where thermal runaway has occurred in an intended path.

Third, according to still another aspect of the present disclosure, a problem to be solved is to increase the stability of battery assemblies by increasing heat resistance or fire resistance.

Fourth, according to yet another aspect of the present disclosure, a problem to be solved is to add a process of inserting an insertion member (or filler portion) into a space formed between a bus bar assembly and a plurality of battery cells, while minimizing changes in the existing assembly process of battery assemblies.

Fifth, according to yet another aspect of the present disclosure, a problem to be solved is to provide an assembling method that facilitates disposition of an insertion member when assembling a battery assembly.

Meanwhile, the battery assembly according to the present disclosure can be widely applied in the field of electric vehicles, battery charging stations, and green technology, such solar power generation, and wind power generation using batteries. In addition, the battery assembly according to the present disclosure can be used in eco-friendly electric vehicles, hybrid vehicles, etc. to prevent climate change by suppressing air pollution and greenhouse gas emissions.

To solve the above-described problems, a battery assembly according to the present disclosure may include: a plurality of battery cells arranged in a preset stacking direction; an accommodating case accommodating the plurality of battery cells; an insertion space defined between the plurality of battery cells and the accommodating case along the stacking direction; and an insertion member positioned in the insertion space, wherein the insertion member may include refractory particles; and a binder that binds the refractory particles to form a preset three-dimensional shape.

In addition, the binder may be melted at a preset temperature or higher.

In addition, the insertion member may form a cylindrical shape as the refractory particles are bound by the binder.

Meanwhile, at least one end of the insertion member of the cylindrical shape may be tapered.

One tapered end among the two ends of the insertion member may be disposed to face an upper portion of the accommodating case.

In addition, each area adjacent to two ends of the insertion member of the cylindrical shape may have the same shape.

In addition, the diameter of the insertion member of the cylindrical shape may be smaller than the height of the insertion member of the cylindrical shape.

In addition, the diameter of the insertion member of the cylindrical shape may be smaller than or equal to the thickness of any one battery cell among the plurality of battery cells.

When the binder melts the temperature or higher, the volume occupied by the refractory particles in the insertion space may be 50% or more of the volume of the insertion space.

Meanwhile, the melting point of the refractory particles may be higher than the ignition point of the plurality of battery cells.

In addition, the binder may begin to melt at 200° C. (degree Celsius).

Meanwhile, the refractory particles may include a porous material, and the porosity of the porous material is 20 percent (%) or more and 30 percent (%) or less.

Meanwhile, the amount of the refractory particles accommodated in the binder may be an amount that may fill 50% or more of the insertion space.

In addition, the refractory particles may include silicon dioxide.

Meanwhile, a battery assembly according to the present disclosure may further include a heat-shielding member positioned between the plurality of battery cells to face adjacent battery cells.

In addition, a battery assembly according to the present disclosure may further include a bus bar electrically connected to the plurality of battery cells, wherein the insertion space may be positioned between the bus bar and the plurality of battery cells.

Meanwhile, the accommodating case may further include: an accommodating body that includes an open upper surface and accommodates the plurality of battery cells through the open upper surface; and an accommodating cover that is coupled with the accommodating body and that covers the open upper surface.

Meanwhile, an assembling method of a battery assembly according to the present disclosure may include stacking the plurality of battery cells; coupling the accommodating cover with the plurality of stacked battery cells; inserting an insertion member into an insertion space formed between the plurality of battery cells and the accommodating cover along the stacking direction; and coupling the accommodating body with the accommodating cover.

In addition, the assembling method of the battery assembly may further include forming a heat dissipation portion on a body bottom surface that forms a bottom surface of the accommodating body, prior to the coupling the accommodating body with the accommodating cover.

In addition, the assembling method of the battery assembly may further include a first inverting step of inverting the accommodating cover and the plurality of battery cells coupled with the accommodating cover, between the coupling the accommodating cover with the plurality of stacked battery cells and the inserting the insertion member into the insertion space.

In addition, the assembling method of the battery assembly may further include a second inverting step of inverting the accommodating cover and the accommodating body so that the accommodating body is positioned above the accommodating body, after the coupling the accommodating body with the accommodating cover.

First, according to one aspect of the present disclosure, the escape of a high-temperature gas or flame in the direction of a lead tab or tab of a battery cell where thermal runaway has occurred in a battery accommodated in a battery assembly (e.g., battery module) may be prevented or mitigated.

Second, according to another aspect of the present disclosure, a high-temperature gas generated from a battery cell where thermal runaway has occurred may be vented in an intended path.

Third, according to still another aspect of the present disclosure, add a process of inserting an insertion member (or insertion member material or filler portion) into a space formed between a bus bar assembly and a plurality of battery cells may be added to the existing assembly process of battery assemblies.

Fourth, according to yet another aspect of the present disclosure, disposition of an insertion member may be facilitated when assembling a battery assembly.

Fifth, according to yet another aspect of the present disclosure, the stability of battery assemblies may be improved by increasing heat resistance or fire resistance of battery assemblies.

### BRIEF DESCRIPTION OF THE DRAWINGS

FIG. 1 shows an example of a battery assembly according to the present disclosure.

FIG. 2 shows an example of an exploded battery assembly according to the present disclosure.

FIG. 3 shows a top view of a battery assembly according to the present disclosure.

FIG. 4 shows an enlarged view of part S1 of FIG. 3.

FIG. 5 schematically shows an example of an insertion member accommodated in an insertion space viewed from above.

FIGS. 6A to 6C show enlarged views of an example of an insertion member accommodated in an insertion space.

FIG. 7A shows an enlarged view of a part of an insertion member. FIG. 7B shows an example of forming an insertion member using refractory particles and a binder.

FIG. 8 shows a top cross-sectional view of an example of a battery assembly according to the present disclosure.

FIG. 9 shows another example of an insertion member accommodated in an insertion space.

FIG. 10 shows one side view of an example of a battery assembly according to the present disclosure.

FIG. 11 shows one side view of another example of a battery assembly according to the present disclosure.

FIG. 12 schematically shows the shape in which a binder melts and refractory particles are piled up as grains in the insertion space.

FIG. 13 shows an example of movement of refractory particles due to flame or a high-temperature gas.

FIG. 14 shows an example of a manufacturing process of a battery assembly according to the present disclosure.

FIG. 15 shows another example of a battery assembly according to the present disclosure.

### DETAILED DESCRIPTION

Hereinafter, preferred embodiments of the present disclosure will be described in detail with reference to the attached drawings. The configuration or control method of the apparatus described below is only for explaining the embodiments of the present disclosure and is not intended to limit the scope of the present disclosure, and the same reference numerals used throughout the specification indicate the same components.

A battery assembly 200 and 300 according to the present disclosure is a general term for a battery module or a battery pack. Therefore, a battery assembly 200 and 300 according to the present disclosure may refer to not only a battery module but also a battery pack that accommodates battery cells without a battery module, such as a cell to pack (CTP).

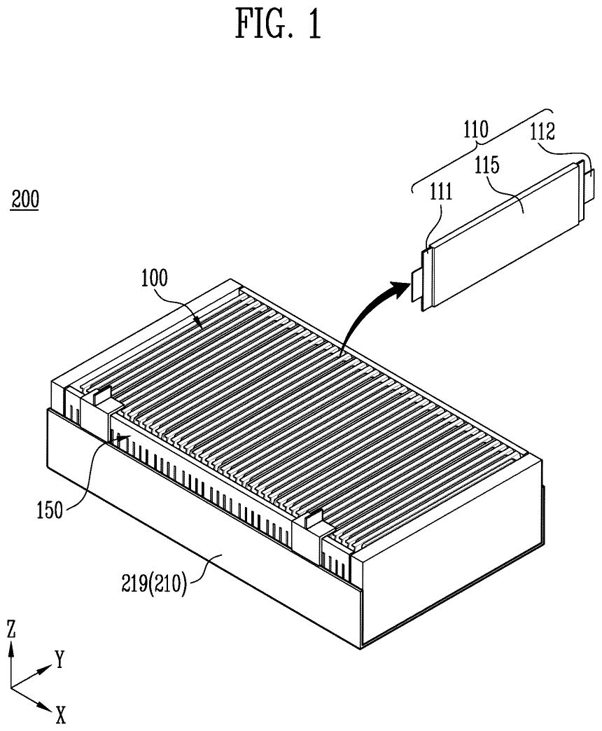

FIG. 1 shows an example of a battery assembly 200 according to the present disclosure.

Referring to FIG. 1, the battery assembly 200 may include a plurality of battery cells 110 and an accommodating case 210 accommodating the plurality of battery cells 110.

Meanwhile, each of the plurality of battery cells 110 may include a main body portion 115 producing or storing electrical energy, and lead tab portions 111 and 112 protruding from the main body portion 115 to the outside of the main body portion 115. The main body portion 115 may include therein an electrode assembly (not shown) including a cathode and an anode therein for producing and storing electrical energy.

In addition, the main body portion 115 may further include an electrolyte (not shown) in contact with the electrode assembly. The electrolyte may be liquid or solid. In addition, when the electrolyte is liquid, the electrode assembly may further include a separator to separate the cathode and the anode. Referring to FIG. 1, the main body portion 115 may be in the form of a pouch sealed with a film-type exterior material.

FIG. 1 shows an example of a pouch-type battery cell 110, but the present invention is not limited thereto. Therefore, the present invention is applicable to prismatic and cylindrical battery cells.

Specifically, the lead tab portion 111 and 112 may include a first lead tab portion 111 and a second lead tab portion 112 protruding from both side surfaces of the main body portion 115 in a direction away from the main body portion 115. As an example, the lead tab portion 111 and 112 may have both tabs on one side surface.

Meanwhile, the accommodating case 210 is intended to protect the plurality of battery cells 110 from external shock such as vibration. The accommodating case 210 may include a accommodating body 219 that forms a part of an accommodating space 280 accommodating the plurality of battery cells 110, which will be described later.

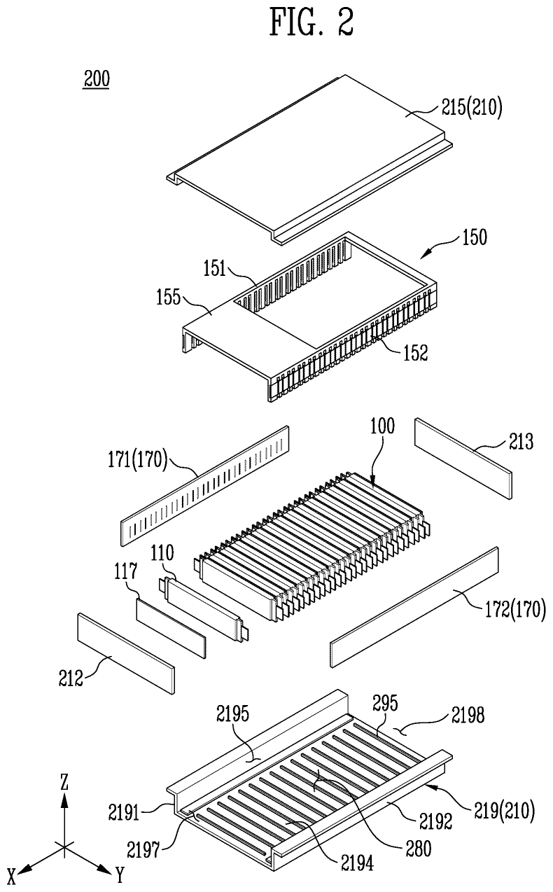

In addition, the battery assembly 200 may further include a bus bar assembly 150 that electrically connects the plurality of battery cells 110 to the outside. The bus bar assembly 150 may include a bus bar 170 (see FIG. 2) that electrically connects the plurality of battery cells 110 to output a preset voltage. The bus bar assembly 150 or the bus bar 170, which will be described later, assembled with the plurality of battery cells 110 may be referred to as a cell stack 100.

FIG. 2 shows an example of an exploded battery assembly 200 according to the present disclosure. Referring to FIG. 2, the accommodating case 210 include an accommodating body 219 forming a part of an accommodating space 280 accommodating the plurality of battery cells 110 and an accommodating cover 215 that is coupled with the accommodating body 219 to together form the accommodating space 280.

The plurality of battery cells 110 may be positioned in the accommodating body 219 to overlap along a preset stacking direction (e.g., X-axis direction).

More specifically, the accommodating case 210 may further include: an accommodating body 219 that includes an open upper surface 2195 and accommodates the plurality of battery cells 100 through the open upper surface 2195; and an accommodating cover 215 that is coupled with the accommodating body 219 and that covers the open upper surface 2195.

Therefore, the accommodating cover 215 may be coupled to the accommodating body 219 to form an upper surface of an accommodating space 280 or an upper surface of an accommodating case 210. In other words, the accommodating cover 211 is coupled to the accommodating body 219 to cover the open upper surface 2195 and forms the accommodating space 280 together with the accommodating body 219.

The accommodating space 280 may include a space formed inside the accommodating body 219 and accommodating the cell stack 100. In addition, the accommodating space 280 may further include an insertion space 288, which will be described later.

Meanwhile, the accommodating body 219 may be provided in a channel shape or U shape with an open top. Referring to FIG. 2, among the sides surface of the accommodating body 219, both side surfaces 2197 and 2198 facing each other along the X-axis direction may also be opened.

In other words, the accommodating body 219 may include a body bottom surface 2194 forming a bottom surface of the accommodating space 280 and body side surfaces 2191 and 2192 extending from an edge (not shown) provided in parallel with the stacking direction among the edges of the body bottom surface 2194 toward the accommodating cover 211. A free end of the body side surfaces 2191 and 2192 may be bent to form a flange (not shown). This is for easy coupling with the accommodating cover 211.

Referring to FIGS. 1 and 2, the height of the accommodating body 219 may be smaller than the height of the plurality of battery cells 110. However, this is only an example, and the height of the accommodating body 219 may be greater than or equal to the height of the plurality of battery cells 110.

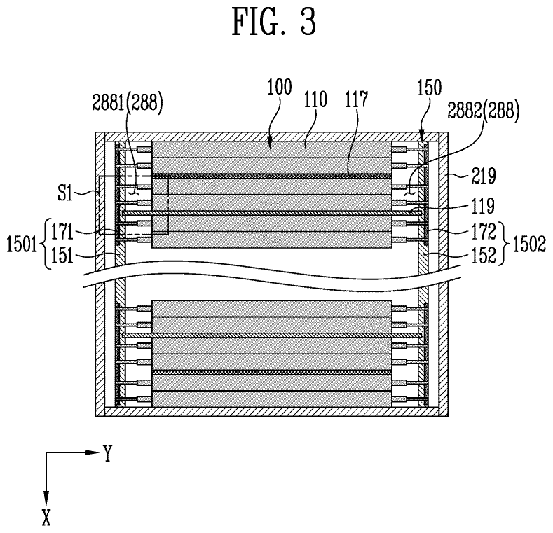

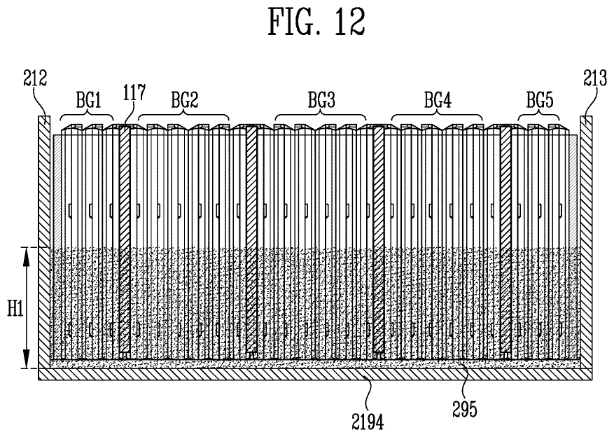

Meanwhile, the cell stack 100 may further include a buffer member 117 or a heat-shielding member 119 (or thermal barrier, see FIG. 3) positioned between the plurality of battery cells 110. The buffer member 117 may be positioned between each of the battery cells 110, or may be positioned between battery groups BG1 to BG5 (see FIG. 12) in which the plurality of battery cells 110 are grouped. This also applies to the heat-shielding member 119.

The heat-shielding member 119 may serve as a thermal barrier to prevent flame or heat from propagating to other adjacent battery cells 110 when thermal runaway occurs in one battery cell 110.

The cell stack 100 may include at least one buffer member 117. Likewise, the cell stack 100 may include at least one heat-shielding member 119. The buffer member 117 and the thermal heat-shielding member 119 may be formed as a single member to simultaneously perform a heat-shielding function and a buffering function.

To this end, the heat-shielding member 119 may be formed in a multi-layer structure along a direction in which the plurality of battery cells 110 are stacked. In other words, one layer of the multi-layer structure may be formed of a flame-retardant material (or refractory material). In addition, other layers of the multi-layer structure may play a role in reducing the pressure exerted on other battery cells 110 when the battery cell 110 is swelling.

The plurality of battery cells 110 and the plurality of buffering members 117 may be provided at preset positions and stacked. For example, referring to FIG. 2, an example is shown where the long edges of the plurality of battery cells 110 are arranged in parallel with the Y-axis direction. Therefore, the plurality of battery cells 110 and the plurality of buffering members 117 will be positioned to overlap in the X-axis direction. This also applies to the heat-shielding member 119.

The heat-shielding member 119 may be formed of a refractory (heat-resistant or flame-retardant) material. For example, the heat-shielding member 119 may include a material such as a refractory polymer or mica.

Meanwhile, referring to FIG. 2, the battery assembly 200 may further include end plates 212 and 213 at both ends of the cell stack 100 along the stacking direction. The end plates 212 and 213 may be provided on both ends of the cell stack 100 or may be connected to both side surfaces 2197 and 2198 of the accommodating body 219.

The end plates 212 and 213 are for preventing both side surfaces of the cell stack 100 from being exposed to the outside.

Meanwhile, the battery assembly 200 may include a bus bar 170 that is electrically connected to the plurality of battery cells 110. In addition, the battery assembly 200 may further include bus bar frames 151, 152, and 155 that support the bus bar 170 and the plurality of battery cells 110. The bus bar 170 and the bus bar frames 151, 152, and 155 may be collectively referred to as a bus bar assembly 150. In other words, the bus bar assembly 150 may include a bus bar 170 that is electrically connected to the plurality of battery cells 110.

The bus bar frames 151, 152, and 155 are electrically connected to the outside to store (or charge) electrical energy in the plurality of battery cells 110, or to supply (or discharge) electrical energy stored in the plurality of battery cells 110 to the outside.

The bus bar assembly 150 may include a first bus bar frame 151 and a second bus bar frame 152 extending along the stacking direction of the plurality of battery cells 110 with the plurality of battery cells 110 interposed therebetween.

In addition, the bus bar assembly 150 may further include a support frame 155 positioned on one side of the bus bar assembly 150 and connecting the first bus bar frame 151 and the second bus bar frame 152.

The bus bar assembly 150 is explained using the case where the lead tab portions 111 and 112 are each positioned in opposite directions from the main body portion 115. On the other hand, in the case where the lead tab portions 111 and 112 are positioned on one side of the main body portion 115 and facing the same direction, the bus bar frames 151 and 152 may be positioned on one side of the main body portion 115, for example, on the upper portion of the main body 115 and electrically connected to the lead tab portion 111 and 112.

The support frame 155 may serve to prevent deformation of the first bus bar frame 151 and the second bus bar frame 152 and support the same. In addition, a part of an electrical device for sensing and controlling the plurality of battery cells 110 may be disposed on the support frame 155.

Referring to FIG. 2, the shape of the bus bar assembly 150 may be a tunnel shape. In addition, the length of the first bus bar frame 151 and the second bus bar frame 152 along the stacking direction may be longer than the length of the support frame 155.

In other words, the support frame 155 may be connected to the first bus bar frame 151 and the second bus bar frame 152 to cover an upper portion of the plurality of battery cells 110. In other words, the support frame 155 may cover not only a part of the upper portion of the plurality of battery cells 110 but also the whole.

Referring to FIG. 2, the bus bar 170 may include: a first bus bar 171 supported by the first bus bar frame 151 and electrically connected to the first lead tab portion 111; and a second bus bar 172 supported by the second bus bar frame 152 and electrically connected to the second lead tab portion 112.

The first bus bar 171 and the second bus bar 172 may be positioned in a direction further away from the plurality of battery cells 110 than the first bus bar frame 151 and the second bus bar frame 152, respectively. In other words, the first bus bar and the second bus bar may be positioned closer to the body side surfaces 2191 and 2192 than the first bus bar frame 151 and the second bus bar frame 152. Therefore, the first lead tab portion 111 and the second lead tab portion 112 may be inserted to slit holes (not shown) formed in the first bus bar frame 151 and the second bus bar frame 152, respectively, to be electrically connected to the first bus bar 171 and the second bus bar 172. However, this is only an example, and the first lead tab portion 111 and the second lead tab portion 112 may be electrically connected to the first bus bar 171 and the second bus bar 172, respectively, in a different manner.

Meanwhile, the battery assembly 200 may further include a heat dissipation portion 295 positioned between the body bottom surface 2194 and the plurality of battery cells 110 to transfer the heat generated from the plurality of battery cells 110 to the outside. The heat dissipation portion 295 may be made of an adhesive material having thermal conductivity, for example, a heat dissipation adhesive. Therefore, the plurality of battery cells 110 may be attached to the body bottom surface 2194 through the heat dissipation portion 295. To this end, the heat dissipation portion 295 may be sprayed or applied on the body bottom surface 2194.

FIG. 3 shows a top view of a battery assembly according to the present disclosure.

The bus bar assembly 150 may include a first bus bar 171 electrically connected to the first lead tab portion 111 and a first bus bar frame 151 supporting the first bus bar 171. The first bus bar 171 and the first bus bar frame 151 may be collectively referred to as a first bus bar assembly 1501. In other words, the first bus bar assembly 1501 may be electrically connected to the first lead tab portion 111 and serve to support the cell stack 100.

Alternatively, the first bus bar assembly 1501 may include only the first bus bar 171 without the first bus bar frame 151.

The bus bar assembly 150 may further include a second bus bar 172 electrically connected to the second lead tab portion 112 and a second bus bar frame 152 supporting the second bus bar 172. The second bus bar 172 and the second bus bar frame 152 may be collectively referred to as a second bus bar assembly 1502. In other words, the second bus bar assembly 1502 may be electrically connected to the second lead tab portion 112 and serve to support the cell stack 100 together with the first bus bar assembly 1501.

Alternatively, the second bus bar assembly 1502 may include only the second bus bar 172 without the second bus bar frame 152.

Referring to FIG. 3, due to the electrical connection between the lead tab portions 111 and 112 and the bus bar assembly 150, an empty space (hereinafter referred to as insertion space 288) may be formed between the plurality of batteries 100 and the bus bar assembly 150.

In other words, a part of the accommodating space 280 formed inside the accommodating case 210 may be a space for accommodating the plurality of battery cells 110, and another part of the accommodating space 280 may be a space for the insertion space 288.

Specifically, the insertion space 288 is a space formed by each main body portion 115, each of the lead tab portions 111 and 112, and the bus bar 170. In normal cases, when thermal runaway occurs in one battery cell 100 of the plurality of battery cells 110 and an off-gas is generated, high-temperature heat may be propagated to other adjacent battery cells through the insertion space 288. To prevent such heat propagation, it is necessary to fill or pack the insertion space 288.

To this end, the battery assembly 200 according to the present disclosure may include an insertion member 270 (see FIG. 5) inserted into the insertion space 288.

In other words, the battery assembly 200 according to the present disclosure may include a plurality of battery cells 110 stacked and arranged in a preset stacking direction; an accommodating case 210 accommodating the plurality of battery cells 100; an insertion space 288 formed between the plurality of battery cells 110 and the accommodating case 210 along the stacking direction; and an insertion member 270 positioned in the insertion space 288.

Meanwhile, referring to FIG. 3, the buffer member 117 may be positioned between the plurality of battery cells 110. The buffer member 117 may be provided between each of the battery cells 110. Alternatively, the buffer member 117 may be positioned between battery groups BG1 to BG5 (see FIG. 12) in which adjacent battery cells 110 are grouped into a preset number of groups.

Referring to FIG. 3, the length of the buffer member 117 along the direction from the first bus bar frame 151 toward the second bus bar frame 152 is illustrated to be less than or equal to the length of the main body portion 115 (see FIG. 1), but is not limited thereto.

Meanwhile, referring to FIG. 3, the heat-shielding member 119 may be positioned between the plurality of battery cells 110. The heat-shielding member 119 may be provided between each of the battery cells 110. Alternatively, the heat-shielding member 119 may be positioned between battery groups BG1 to BG5 in which adjacent battery cells 110 are grouped into a preset number of groups.

The battery group BG1 to BG5 refers to a set of battery cells in which adjacent battery cells 110 among the plurality of battery cells 110 are grouped into a preset number of groups. The plurality of battery cells 110 may be grouped into the number of groups for a preset target voltage or target current, and then the battery groups BG1 to BG5 may be connected in series or parallel using the bus bar 170.

Referring to FIG. 3, the length of the buffer member 117 along the direction from the first bus bar frame 151 toward the second bus bar frame 152 is illustrated to be less than or equal to the length of the main body portion 115 (see FIG. 1), but is not limited thereto.

Meanwhile, referring to FIG. 3, the heat-shielding member 119 and the buffer member 117 are illustrated as separate members, but alternatively, they may be formed as one member as described above. This may be referred to as an insertion member (not shown).

In other words, the insertion member may be positioned between the plurality of battery cells 110 to shield heat during thermal runaway and buffer surface pressure of the battery cells during swelling.

Meanwhile, the length of the heat-shielding member 119 along the direction from the first bus bar frame 151 to the second bus bar frame 152 may be longer than the length of the main body portion 115. More specifically, the heat-shielding member 119 may contact with the first bus bar assembly 1501 and the second bus bar assembly 1502. Through this, the heat-shielding member 119 may be able to block or mitigate the propagation of heat or flame to other places during thermal runaway in any battery cell 110.

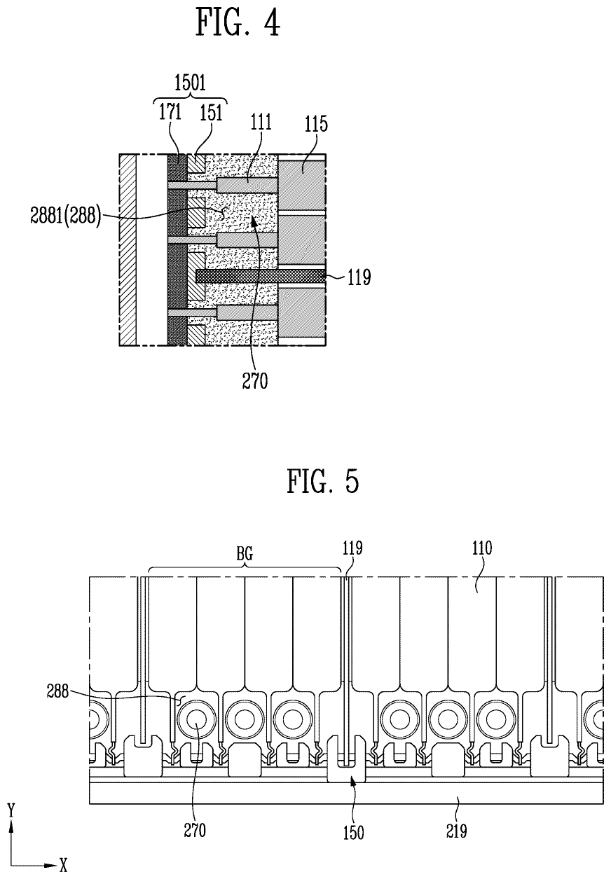

FIG. 4 shows an enlarged view of part S1 of FIG. 3.

Specifically, the part S1 may be a partial area of the insertion space 288. The battery assembly 200 may further include an insertion space 288 formed between the cell stack 100 and the bus bar assembly 150 or between the plurality of battery cells 110 and the bus bar 170.

Specifically, the battery assembly 200 may include a first insertion space 2881 and a second insertion space 2882 (see FIG. 3) between one side surface of each main body portion 115 of the plurality of battery cells 110 and the first bus bar 171 and between the other side surface of each main body portion 115 of the plurality of battery cells 110 and the second bus bar 172, respectively.

Referring to FIGS. 3 and 4, the insertion member 270 may be positioned in at least one of the first insertion space 2881 or the second insertion space 2882. In FIG. 4, only the position of the insertion member 270 is indicated to emphasize that it is positioned in the insertion space 288, and the shape of the insertion member 270 is not specifically illustrated.

In other words, the insertion member 270 may be positioned in at least one of the first insertion space 2881, or the second insertion space 2882.

More specifically, the part S1 of FIG. 4 illustrates a part of the first insertion space 2881. One side surface of the main body portion 115 may be a side surface where the first lead tab 111 is positioned, and the other side surface of the main body portion 115 may be a side surface where the second lead tab 112 is positioned.

Meanwhile, the first insertion space 2881 may be separated by the first lead tab portion 111. In addition, the second insertion space 2882 may be separated by the second lead tab portion 112. However, when the cell stack 100 is accommodated in the accommodating body 219, since the length of the first lead tab portion 111 and the second lead tab portion 112 along the height direction of the accommodating case 210 or the accommodating body 219 is smaller than the height of the battery cell 110, each of the first insertion space 2881 and the second insertion space 2882 may communicate with each other.

In addition, the first insertion space 2881 and the second insertion space 2882 may communicate with each other through a space between the plurality of battery cells 110 and the accommodating cover 215. Therefore, the first insertion space 2881 and the second insertion space 2882 may not be spaces that are separated and isolated from each other, but may be spaces that may communicate with each other.

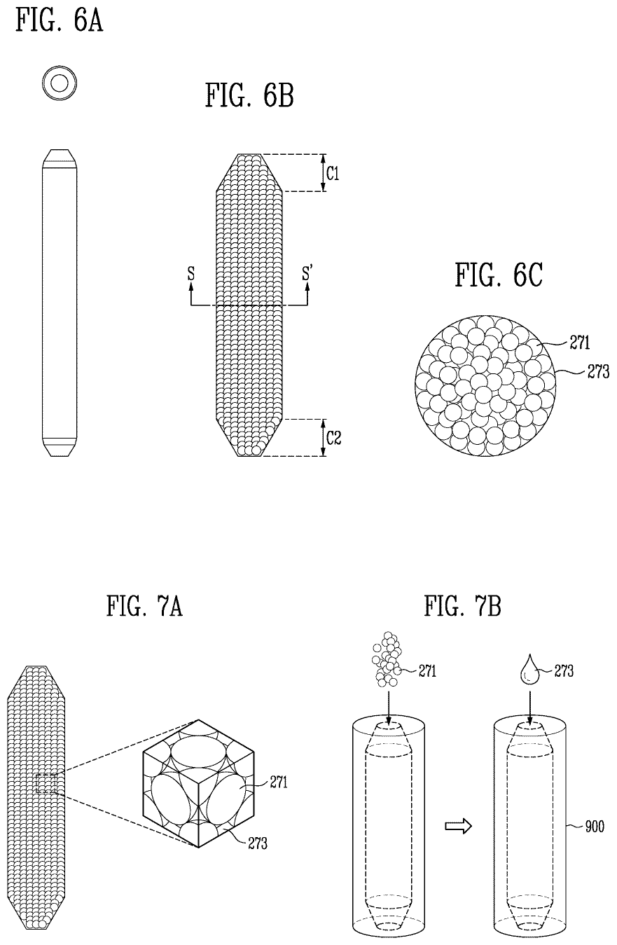

Meanwhile, since the first insertion space 2881 and the second insertion space 2882 are connected to each other, when a binder 273 (see FIG. 6C) that binds refractory particles 271 (see FIG. 6C) in the insertion member 270 positioned in the first insertion space 2881 melts, upon the application of an external force such as gas flow or flame flow, the insertion member 270 may be moved by the external force from one position to another position within the first insertion space 2881. Likewise, upon the application of an external force such as gas flow or flame flow, the insertion member 270 positioned in the second insertion space 2882 may be moved by the external force from one position to another position within the second insertion space 2882. Likewise, upon the application of an external force such as gas flow or flame flow, the insertion member 270 may be moved by the external force from the first insertion space 2881 to the second insertion space 2882 or vice versa.

FIG. 5 schematically shows an example of an insertion member accommodated in an insertion space viewed from above.

The battery assembly 200 may have an insertion space 288 formed between the plurality of battery cells 110 and the bus bar assembly 150 (or the bus bar 170). The insertion space 288 may be formed when each lead tab portion 111 and 112 is connected to the bus bar assembly 150 (or the bus bar 170).

Meanwhile, the insertion space 288 may include a plurality of separate spaces that are separated by each of the lead tab portions 111 and 112. Each of the lead tab portions 111 and 112 does not separate the plurality of separate spaces to be isolated. In other words, since the length of each lead tab portion 111 and 112 along the height direction of the accommodating case 210 is smaller than the height of the accommodating space 280, only a part is partitioned along the height of the accommodating space 280.

In other words, since the length of each lead tab portion 111 and 112 along the height direction of the accommodating case 210 is smaller than the length of each main body portion 115, the plurality of insertion spaces 288 may be separated by each lead tab portion 111 and 112 or may communicate with each other.

More specifically, a plurality of first insertion spaces 2881 may be formed by the first lead tab portion 111, and the plurality of first insertion spaces 2881 may communicate with each other. Likewise, a plurality of second insertion spaces 2882 may be formed by the second lead tab portion 112, and the plurality of second insertion spaces 2882 may communicate with each other.

Therefore, as described above, the plurality of separate spaces may be able to communicate with each other. In addition, the insertion members 270 may also be provided in a plural number and inserted into each of the plurality of separate spaces.

Meanwhile, referring to FIG. 5, the battery assembly 200 may further include a heat-shielding member 119 positioned between the plurality of battery cells 110. Alternatively, the battery assembly 200 may further include a heat-shielding member 119 positioned between battery groups BG in which the plurality of battery cells 110 are grouped.

Referring to FIG. 5, the heat-shielding member 119 may be provided in parallel with the plurality of battery cells 110 and extend to the bus bar assembly 150. More specifically, the heat-shielding member 119 may extend to the bus bar frame 151 and 152 and be inserted into the bus bar frame 151 and 152. In this case, the insertion member 270 may not be inserted into the space to which the heat-shielding member 119 is inserted. This is to prevent interference between the insertion member 270 and the heat-shielding member 119.

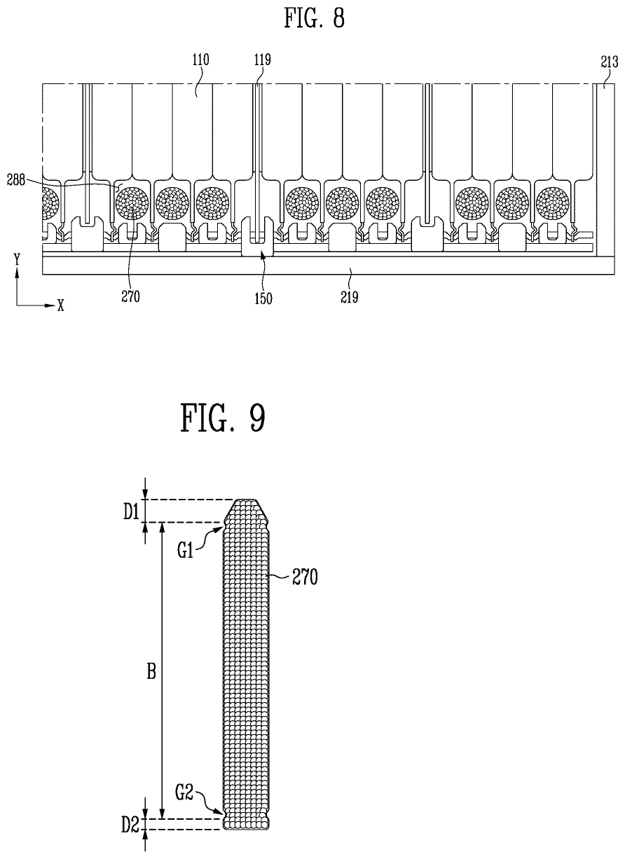

FIGS. 6A to 6C show enlarged views of an example of an insertion member 270 accommodated in an insertion space 288 (see FIG. 8).

As shown in FIG. 6A, the insertion member 270 may have a cylindrical shape. Therefore, when the insertion member 270 is viewed from above, it may have a shape similar to the circular figure illustrated above the cylindrical shape in FIG. 6A.

Referring to FIG. 6A, the approximate shape of the insertion member 270 may be a cylindrical shape. In addition, the height of the insertion member 270 of the cylindrical shape may be smaller than the diameter of the insertion member 270.

In addition, considering the size of the insertion space 288, the diameter of the insertion member 270 may be less than or equal to the thickness of any one of the plurality of battery cells. This is to facilitate insertion of the insertion member 270 into the insertion space 288.

Meanwhile, both ends of the insertion member of the cylindrical shape 270 may be provided in a tapered shape. This is to facilitate insertion of the insertion member 270 into the insertion space 288. In other words, when the insertion member 270 is inserted into the insertion space 288, both ends may be tapered so that the insertion member 270 may be guided into the insertion space 288.

In addition, both ends of the insertion member 270 may have a symmetrical shape. This is to increase the convenience of assembling the battery assembly 200 by inserting the insertion member 270 into the insertion space 288 without distinguishing between the top and the bottom.

In other words, the approximate shape of areas C1 and C2 (see FIG. 6B) adjacent to both ends of the insertion member 270 may be the same shape.

FIG. 6A shows only an approximate shape of the insertion member 270, and specifically, as illustrated in FIG. 6B, refractory particles 271 may gather to form a cylindrical shape with both ends tapered.

Referring to FIG. 6C, the insertion member 270 may include refractory particles 271 and a binder 273 that binds the refractory particles (or may be called as a flame-mitigation particles) 271 to form a preset three-dimensional shape.

Preferably, the insertion member 270 may include a plurality of refractory particles 271 and a binder 273 that binds the plurality of refractory particles 271 among the plurality of refractory particles 271 to form a preset three-dimensional shape.

The plurality of refractory particles 271 may be a solid filler provided in the form of solid particles, powder, granules, pellets, or beads. This is to prevent or mitigate flame propagation or heat propagation through the insertion space 288 when thermal runaway occurs in any battery cell 110.

The size of the refractory particles 271 may preferably be 2 μm (micrometer) or more and less than or equal to the length or thickness of one battery cell 110 along the stacking direction.

Preferably, the refractory particles 271 may have a micro-size. These micro-sized refractory particles 271 may be referred to as microbeads or microgranules.

The size of the refractory particles 271 may be the size of the diameter assuming a spherical shape with the radius being the distance from the center (or center of gravity) of the refractory particles 271 to the farthest outer edge. Therefore, the size of the refractory particles 271 may be the maximum outer diameter of the refractory particles 271. Alternatively, the size of the refractory particles 271 may be an average value calculated after measuring the refractory particles 271 from several directions. This may also be applied even when the refractory particles 271 are in the form of particles.

The reason why the size of the refractory particles 271 needs to be 2 μm or more is because the refractory particles 271 need to be prevented from escaping into a space other than the insertion space 288, for example, a space between the accommodating case 210 (see FIG. 1) and the bus bar assembly 150 (see FIG. 2).

The lead tab portions 111 and 112 (see FIG. 1) may be formed through the bus bar 170 to be electrically connected to the bus bar 170 (see FIG. 2). To this end, the bus bar 170 may include a slit hole (not shown) formed through the bus bar 170. The lead tab portion 111 and 112 may be inserted into the slit hole and then welded. The slit hole will be closed by welding, and at this time, a weld bead (not shown) may be formed in the welding area of the slit hole due to welding. The weld bead is a unique shape that may be generated during welding. The weld bead may also have fine pores. Since the size of the pores formed in the weld bead is approximately 2 μm, the size or outer diameter of the refractory particles 271 may preferably be 2 μm or more. This is because the refractory particles 271 may be prevented from escaping through the pores. In other words, preferably, the size of the refractory particles 271 may be larger than or equal to the size of the pores formed in the weld bead.

In addition, the size or outer diameter of the refractory particles 271 may be less than or equal to the length or thickness of one battery cell along the stacking direction. This is because only when the size or outer diameter of the refractory particles 271 is smaller than the distance between one lead tab portion 111, 112 and the other lead tab portion 111, 112 adjacent to the one lead tab portion 111, 112, the refractory particles 271 may be accommodated in the insertion space 288 (see FIG. 3) formed between the one lead tab portion 111 and 112 and the other lead tab portion 111 and 112.

For example, when the thickness of the battery cell 110 is 15 mm, the size or outer diameter of the refractory particles 271 may be 15 mm or less.

In other words, the size of the refractory particles 271 needs to be larger than or equal to the gap between one battery cell 110 among the plurality of battery cells 110 and another battery cell 110 adjacent to the one battery cell 110 along the stacking direction and may be smaller than or equal to the gap between the one lead tab portion 111 and 112 and the one lead tab portion 111 and 112 along the stacking direction.

In addition, the refractory particles 271 are not uniformly determined by one size or material, but may be a mixture of refractory particles 271 of various sizes or materials.

The melting point of the refractory particles 271 may preferably be higher than a preset temperature (or allowable temperature), which will be described later. Preferably, the allowable temperature may be 200° C. (degrees Celsius). The binder 273 may begin to melt when the allowable temperature is reached. Therefore, the melting point of the refractory particles 271 needs to be higher than the allowable temperature.

In addition, the melting point of the refractory particles 271 may be higher than the ignition point of the plurality of battery cells 110. The ignition point of the plurality of battery cells 110 may be a temperature at which venting occurs in the battery cell 110. Alternatively, the ignition point may be the temperature of an electrolyte accommodated inside the battery cell 110, that is, inside the main body portion 115, when an exterior material (or accommodating case) of the battery cell 110 is torn or opened in a thermal runaway situation.

Therefore, when thermal runaway begins in one of the battery cells 110, the binder 273 begins to melt, but the refractory particles 271 may maintain their solid form. This is to prevent the refractory particles 271 from burning or melting.

For example, even when thermal runaway of a battery cell 110 occurs, the refractory particles 271 may not burn or melt, and the external shape of the refractory particles 271 may be maintained without a significant change.

The refractory particles 271 may include a porous material. A porous material refers to a material that contains pores within its structure. The shape of the pores may be an amorphous and irregular shape. Specifically, when the refractory particles 271 include silica gel of a particle shape or a powder form, the porosity of the refractory particles 271 may be 20 percent (%) or more and 30 percent (%) or less.

In addition, the refractory material may be an inorganic compound. In other words, the refractory particles 271 may include a refractory material formed of an inorganic compound. The above inorganic compound may be any one compound selected from the group including alum (K₂SO₄·Al₂(SO₄)₃·24H₂O), borax (Na₂B₄O₇-10H₂O), lime water (Ca(OH)₂ aqueous solution), quicklime (CaO), milk of lime (white emulsion made by mixing Ca(OH) 2 with water), slaked lime (Ca(OH)₂), washing soda (Na₂CO₃·10H₂O), apatite (Cas(PO₄)₃OH), baking powder (salt mixture of NaHCO₃ and tartaric acid), baking soda, (NaHCO₃), sodium thiosulfate pentahydrate (Na₂S₂O₃·5H₂O), silica (silicon dioxide, SiO₂), alumina (aluminum oxide, Al₂O₃), calcium oxide (CaO), calcium sulfate (CaSO₄), calcium chloride (CaCl₂)), sodium carbonate (Na₂CO₃), potassium chloride (KCl), magnesium oxide (MgO), zirconium oxide (ZrO₂), chromium oxide (Cr₂O₃), aluminum hydroxide (Al(OH)₃), antimony trioxide (Sb₂O₃), antimony pentoxide (Sb₂O₅), magnesium hydroxide (Mg(OH)₂), a zinc borate compound, a phosphorus-based compound, a nitrogen-based guanidine compound, or a molybdenum compound, or a mixture thereof.

For example, assuming that the refractory particles 271 are formed of silica (silicon dioxide), considering the melting point of silica (1713° C. (degree Celsius)), the refractory particles 271 may minimize the propagation of the heat or off-gas generated during thermal runaway to another plate. In addition, the refractory particles 271 will maintain their shape without a change in a thermal runaway situation of a battery cell.

In another example, the refractory particles 271 may be formed of silica gel. The silica gel is a porous material in powder form made by treating an aqueous solution of sodium silicate (Na₂SiO₃) with an acid. Specifically, the silica gel may be obtained by mixing sodium silicate and an aqueous inorganic acid solution (such as sulfuric acid) to form a silica hydrosol and curing the hydrosol into a hydrogel. Considering the conventional method of producing the silica gel described above, the main component (accounting for more than 50%) of the silica gel is silicon dioxide, and it may further contain aluminum oxide, iron (III) oxide (Fe₂O₃, also referred to as ferric oxide) or sodium as other components. Therefore, the melting point of the silica gel may also be approximately 1600° C. (degree Celsius) or higher.

Preferably, the silica gel may contain more than 90 percent (%) of silicon dioxide. In addition, since the silica gel is a porous material, the porosity of the refractory particles 271 may be 20 percent (%) or more and 30 percent (%) or less.

In other words, the refractory particles 271 may include silicon dioxide.

FIG. 7A shows an enlarged view of a part of an insertion member 270. FIG. 7B shows an example of forming an insertion member 270 using refractory particles 271 and a binder 273.

Referring to FIG. 7A, the insertion member 270 may include refractory particles 271 and a binder 273 that binds the refractory particles 271. The refractory particles 271 are provided in a plural number, and the binder 273 may serve as a crosslinker between the plurality of refractory particles 271.

In FIG. 7A, the refractory particles 271 are assumed to be spherical for convenience, but the shape of the refractory particles 271 is not limited to a spherical shape. Therefore, the refractory particles 271 may have an amorphous shape. In addition, the refractory particles 271 are not determined by one size, but may be a mixture of refractory particles 271 of various sizes.

The binder 273 may be melted at a preset allowable temperature or higher. In other words, when thermal runaway occurs in at least one battery cell 110 among the plurality of battery cells 110 and the temperature rises, the temperature around the battery cell 110 where thermal runaway has occurred will increase. At this time, when the temperature of the binder 273 reaches the allowable temperature, the binder 273 may begin to melt. Considering the temperature at the time of thermal runaway of a battery cell 110, the allowable temperature may preferably be 200° C. (degree Celsius).

When the binder melts above the allowable temperature, the outer shape of the insertion member 270 will not be maintained. Therefore, at least a part of the plurality of refractory particles 271 that have maintained the cylindrical shape by the binder 273 will be changed into a freely movable state.

In other words, after the movement of the plurality of refractory particles 271 is suppressed by the binder 273, at least a part of the plurality of refractory particles 271 may be released from the binding bond by the binder 273, as the binder melts.

Therefore, preferably, the melting temperature of the refractory particles 271 will be higher than the allowable temperature. This is because the refractory particles 271 need to be prevented from burning or melting above the allowable temperature.

Referring to FIG. 7B, the binder 273 may be a material that is cured while binding the plurality of refractory particles 271 to each other in a liquid state. Alternatively, the binder 271 may be a material that is cured or foamed using a separate curing agent (not shown) after the liquid binder 273 and the plurality of refractory particles 271 are mixed. The curing agent may be a material that is cured by ultraviolet rays (UV), or a material that is cured over time when mixed with the binder 273. Meanwhile, the three-dimensional shape of the insertion member may be determined by a mold 900 (or molding frame).

The interior of the mold 900 will have a shape capable of forming the cylinder illustrated in FIG. 7A. Alternatively, the interior of the mold 900 may have a rectangular parallelepiped or polyhedral shape. The plurality of refractory particles 271 and the binder 273 may be placed in the mold 900 to mold the insertion member 270 to have the three-dimensional shape.

The insertion member 270 may simply contain the plurality of refractory particles 271 in the form of beads or granules without the binder 273. However, in this case, not only does it take more time to insert the plurality of refractory particles 271 into the insertion space 288, but also the insulation resistance may decrease when the refractory particles 271 retain moisture.

Therefore, referring to FIG. 7B, not only may the insertion member 270 be molded into a desired shape through the binder 273, but also may an effect of coating the outer surface of the insertion member 270 with the binder 273 be obtained, so that the moisture resistance or moisture prevention effect of the insertion member 270 is improved.

The material of the binder 273 may be a polymer such as resin. In addition, the binder 273 may also be a heat-resistant or flame-retardant material that does not melt up to the allowable temperature.

Meanwhile, the plurality of refractory particles 271 may be formed of other materials other than silica gel as long as they have porosity and flame retardancy (heat resistance or fire resistance).

Meanwhile, as another example, the plurality of refractory particles 271 may refer to a polymer material having a V-0 rating in the 94V test (vertical burning test) of Underwriter's Laboratory (UL), which is a flame retardancy standard for polymer materials.

Specifically, the plurality of refractory particles 271 may include a flame-retardant polymer. The flame retardant material includes phosphorus-based, halogen-based, and inorganic flame retardants. Preferably, a phosphorus-based flame retardant material may include a phosphate compound, a phosphonate compound, a phosphinate compound, a phosphine oxide compound, a phosphazene compound, and metal salts thereof. These may be used alone or in combination of two or more types.

In another specific example, the phosphorus-based flame retardant may be diphenyl phosphate, diaryl phosphate, triphenyl phosphate, tricresyl phosphate, trixylenyl phosphate, tri (2,6-dimethylphenyl)phosphate, tri (2,4,6-trimethylphenyl)phosphate, tri (2,4-ditertibutylphenyl)phosphate, tri (2,6-dimethylphenyl)phosphate, bisphenol-A bis(diphenyl phosphate), resorcinol bis(diphenyl phosphate), resorcinol bis [bis(2,6-dimethylphenyl)phosphate], resorcinol bis [bis(2,4-ditertibutylphenyl)phosphate], hydroquinone bis [bis(2,6-dimethylphenyl)phosphate], hydroquinone bis [bis(2,4-ditertibutylphenyl)phosphate], an oligomeric phosphoric acid ester-based compound or the like, but is not limited thereto. These may be applied alone or in the form of a mixture of two or more types.

The binder 273 may fill a plurality of pores (not shown) formed between the plurality of refractory particles 271 in contact and may coat the outer surface of the insertion member 270.

FIG. 8 shows a top cross-sectional view of an example of a battery assembly 200 according to the present disclosure.

Referring to FIGS. 2 and 8, FIG. 8 shows a part (specifically, the area where the accommodating body 219 and one of the end plates 212 and 213 meet) viewed from above toward the accommodating body 219 after removing the accommodating cover 215.

As described above, the movement of the refractory particles 271 is suppressed by the binder 273, and then at least a part of the refractory particles 271 may be released from the binding bond by the binder as the binder melts.

Therefore, preferably, the melting temperature of the refractory particles 271 will be higher than the allowable temperature. This is because, although the binder begins to melt above the allowable temperature, the refractory particles 271 need to be prevented from burning or melting.

Referring to FIG. 8, the insertion space 288 may be partitioned into a plurality of separate spaces, and a plurality of insertion members 270 may be inserted into at least some of the separate spaces.

The battery assembly 200 may further include a heat-shielding member 119 positioned between the battery cells 110 along the stacking direction (e.g., X-direction) of the plurality of battery cells 110. Since the heat-shielding member 119 extends in a direction in which the lead tab portions 111 and 112 protrude (e.g., Y-direction) among the directions perpendicular to the stacking direction and is connected to the bus bar assembly 150, not all the plurality of separate spaces may be filled with the insertion member 270.

However, when the heat-shielding member 119 is absent, the insertion member 270 may each be inserted into all of the plurality of separate spaces.

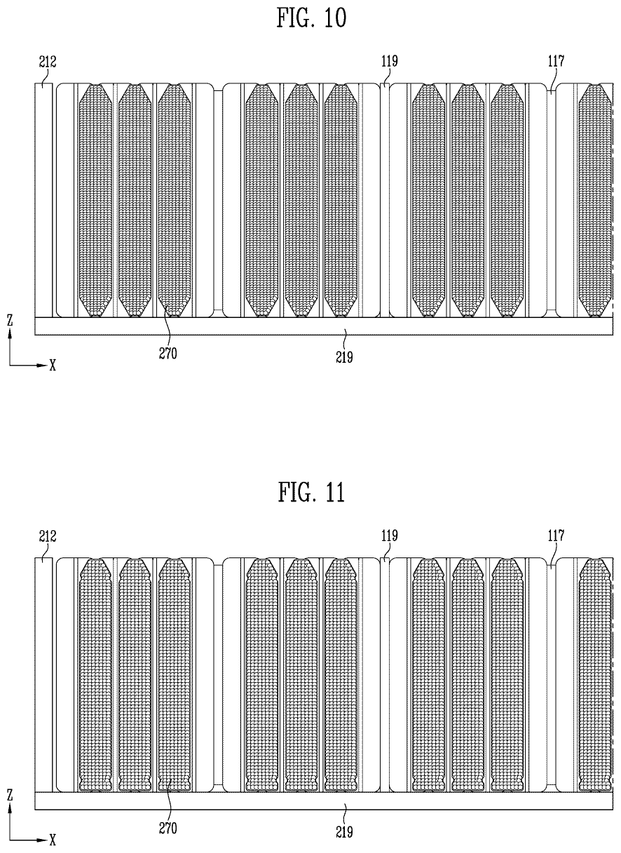

FIG. 9 shows another example of an insertion member 270 accommodated in an insertion space 288 (see FIG. 8).

Referring to FIG. 9, the approximate shape of the insertion member 270 may be a cylindrical shape. In addition, the height of the insertion member 270 of the cylindrical shape may be smaller than the diameter of the insertion member 270.

In addition, considering the size of the insertion space 288, the diameter of the insertion member 270 may be less than or equal to the thickness of one of the plurality of battery cells. This is to facilitate insertion of the insertion member 270 into the insertion space 288.

Meanwhile, unlike the example of the insertion member in FIG. 6A, referring to FIG. 9, one end D1 of both ends of the insertion member 270 of the cylindrical shape may be provided in a tapered shape, and the other end D2 may be provided in a flat shape. This is because more refractory particles 271 may be filled in the insertion space 288 than when both ends are tapered.

In the present specification, one end and the other end of the insertion member refer to an area adjacent to the one end and the other end, including the one end and the other end of the insertion member.

The one end D1 is intended to facilitate insertion of the insertion member 270 into the insertion space 288. In other words, when the insertion member 270 is inserted into the insertion space 288, the one end D1 may be tapered so that the insertion member 270 may be guided into the insertion space 288. In other words, at least one end of the insertion member 270 of the cylindrical shape is tapered. And a tapered end among the two ends of the insertion member 270 is disposed to face an upper portion of the accommodating case 210.

The body portion B of the insertion member 270 excluding both ends D1 and D2 of the insertion member 270 may have a cylindrical shape. Meanwhile, between the one end D1 and the body portion B or between the other end D2 and the body portion B, the insertion member 270 may further include grooves G1 and G2 that are formed by being depressed inward along the circumferential surface of the body portion B. This is to prevent the insertion member 270 from damaging a battery cell 110 adjacent to the insertion member 270 when the insertion member 270 is inserted.

Meanwhile, the insertion member 270 may be formed by binding of refractory particles 271 with a binder 273, but in contrast, the insertion member 270 may also be molded by filling the refractory particles 271 into an exterior material having a preset external shape.

FIG. 10 shows one side view of an example of a battery assembly 200 according to the present disclosure.

Specifically, referring to FIGS. 2 and 10, FIG. 10 shows an area adjacent to one of both end plates 212 and 213 when the battery assembly 200 is viewed after removing body side surfaces 2191 and 2192 and a bus bar assembly 150.

Referring to FIG. 10, the insertion space 288 (see FIG. 8) may include a plurality of separate spaces, and the insertion member 270 may be positioned in at least some of the plurality of separate spaces. When the insertion member 270 may mitigate thermal runaway of the battery cell 110, the insertion member 270 will not necessarily need to be positioned in each of the plurality of separate spaces.

FIG. 11 shows one side view of another example of a battery assembly 200 according to the present disclosure.

Referring to FIG. 11, the insertion space 288 (see FIG. 8) may include a plurality of separate spaces, and the insertion member 270 may be positioned in at least some of the plurality of separate spaces. In other words, unlike FIG. 10, FIG. 11 shows another example of the insertion member 270 shown in FIG. 9 inserted into the insertion space 288.

Referring to FIG. 11, one tapered end D1 (see FIG. 9) of both ends of the insertion member 270 may be positioned in a direction away from the body bottom surface 2194 (see FIG. 2), which is a bottom surface of the accommodating body 219. On the other hand, the other flat end D2 (see FIG. 9) of both ends of the insertion member 270 may be positioned closer to the body bottom surface 2194 than the one end D1. In other words, the one tapered end D1 of both ends of the insertion member 270 may be positioned closer to the accommodating cover 215 than the other flat end D2 of the insertion member 270.

FIG. 12 schematically shows the shape in which a binder 273 melts and refractory particles 271 are piled up as grains in the insertion space 288.

Specifically, FIG. 12 shows an example in which the binder 273 melts above the allowable temperature, and the plurality of refractory particles 271 are separated into grains and filled in the insertion spate 288 along the height direction of the accommodating case 210 or the accommodating body 219 up to a preset filling height H1.

The insertion space 288 may be partitioned into a plurality of separate spaces, and a plurality of insertion members 270 may be inserted into at least some of the separate spaces. The volume of each insertion space 288 may be greater than the total volume of each insertion member 270 inserted into the plurality of separate spaces.

Ultimately, even when it is assumed that all of the binder 273 melts during thermal runaway of the plurality of battery cells 110, the plurality of refractory particles 271 will not be able to fill the insertion space 288 to the top in the height direction of the battery cells 110.

In other words, assuming that the battery assembly 200 reaches the allowable temperature and all of the binder 273 melts, the refractory particles 271 will be able to fill the insertion space 288 up to the filling height H1 in the form of grains.

Referring to FIG. 12, the filling height may be a height indicated by H1 from the body bottom surface 2194, which is a bottom surface of the accommodating body 219.

For example, the filling height H1 shown in FIG. 12 shows an example of a height corresponding to the case where 50% of the volume of the insertion space 288 is filled with the refractory particles 271 after the binder 273 melts.

In other words, when the binder 273 melts above the allowable temperature, the refractory particles 271 may be scattered into grains. In general, the refractory particles 271 may be piled up from the bottom inside the insertion space 288 by their own weight unless there is a strong external impact. In other words, when the binder 273 melts above the allowable temperature and the binding of the refractory particles 271 is released, the refractory particles 271 may be piled up by their own weight on top of the body bottom surface 2194 or a part of the insertion member 370 that has not been melted yet. When all of the binder 273 melts, the refractory particles 271 will fill the insertion space 288 from the body bottom surface 2194 by their own weight.

Even when all of the binder 273 melts, the volume occupied by the refractory particles 271 in the insertion space 288 may be 50% or more of the volume of the insertion space 288 to perform the function of mitigating the propagation of a high-temperature gas or flame.

Therefore, no matter what shape the insertion member 370 is molded into, the volume of the refractory particles 271 may be 50% or more of the volume of the insertion space 288 where the insertion member 370 is positioned.

Meanwhile, the battery assembly 200 may further include a heat dissipation portion 295 between the plurality of battery cells 110 and the body bottom surface 2194. The heat dissipation portion 295 may be a material that may be first applied as a liquid to the body bottom surface 2194 before the plurality of battery cells 110 are accommodated and then cured when a preset elapsed time is elapsed after the plurality of battery cells 110 are accommodated.

Meanwhile, the thickness of the heat dissipation portion 295 may be negligible compared to the height of the accommodating body 219 or the filling height H1.

Meanwhile, the battery assembly 200 may have end plates 212 and 213 positioned at both ends of the plurality of battery cells 110 along the stacking direction. In addition, the plurality of battery cells 110 may form battery groups BG to BG5 as some adjacent battery cells 110 are group. A plurality of battery cells 110 in one battery group may be disposed with the same polarity and connected in parallel. Therefore, each battery group BG to BG5 may have a different polarity disposition from an adjacent battery group BG to BG5.

In addition, the battery assembly 200 may further include a heat-shielding member 119 (see FIG. 3) or a buffer member 117 between the plurality of battery groups BG to BG5.

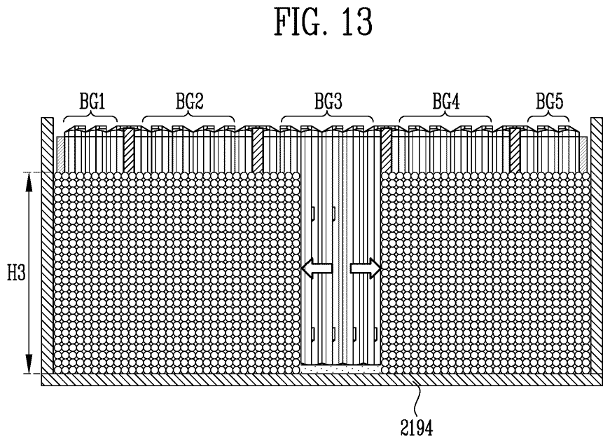

FIG. 13 shows an example of movement of refractory particles due to flame or a high-temperature gas.

Referring to FIG. 13, when the binder 273 that has bound the refractory particles 271 melts, the refractory particles 271 may be unable to maintain the outer shape of the insertion member 270 and may be sequentially stacked starting from the body bottom surface 2149 by gravity.

FIG. 13 briefly illustrates an example in which the binder 273 of all insertion members 270 inserted into the insertion space 288 melts. The shape of the refractory particles 271 is simply exaggerated in size and indicated to be spherical in shape for explanation purposes. In addition, for convenience, it is assumed that all binders 273 are melted.

In contrast, in any one battery cell 110, a binder 273 may first melt in one insertion space 288 where the battery cell 110 is positioned. Therefore, some of the plurality of insertion members 270 may melt, and some others may maintain the three-dimensional shape of the insertion members 270 as it is.

In addition, in any one insertion member 270, some areas may melt, and some other areas may still maintain the outer shape of the insertion member 270.

When the temperature of the insertion member 270 reaches the allowable temperature or higher, the binder 273 may begin to melt, and as illustrated in FIGS. 12 and 13, the plurality of refractory particles 271 may be separated one by one and stacked freely.

Since the binder 273 that has bound the plurality of refractory particles 271 has been removed, the plurality of refractory particles 271 may move freely. Therefore, due to the flow of flame or off-gas generated during thermal runaway, the plurality of refractory particles 271 may receive a force and be moved to another position.

As described above, since the plurality of insertion spaces 288 are connected, when flame is propagated or an off-gas is moved (in the direction of the arrow) from one insertion space 288 where a battery cell 110 in which thermal runaway has occurred is positioned toward another battery cell 110, the plurality of refractory particles 271 may move from the insertion space 288 corresponding to the battery cell 110 where the thermal runaway has occurred to another insertion space 288.

For example, referring to FIG. 13, when thermal runaway occurs in any one battery cell (e.g., any one battery cell belonging to BG3), the temperature of an area adjacent to the one battery cell will rise first. Therefore, the binder 273 of an insertion member 270 adjacent to the one battery cell 110 where the thermal runaway has occurred may melt. Therefore, the refractory particles 271 that were bonded by the melted binder 273 may move freely.

Therefore, when flame or a high-temperature gas spreads to an adjacent battery group, the refractory particles 271 that have been changed into the form of grains may move sideways along the flame or high-temperature gas. FIG. 13 briefly illustrates this for explanation. Through this, the refractory particles 271 in the form of grains will move and fill the remaining space in the insertion space 288 to which the flame or high-temperature gas has not yet spread, thereby mitigating the propagation of the flame or high-temperature gas.

In other words, the refractory particles 271, which are able to move freely in the form of grains as the binder 273 melts, may move to an insertion space 288 corresponding to the position of a battery cell 110 that is normally operable without thermal runaway occurring, due to the pressure generated when thermal runaway occurs in any one battery cell 110 among the plurality of battery cells 110.

Therefore, referring to FIG. 13, the refractory particles 271 may move to areas other than the insertion space 288 corresponding to an area of the third battery group BG3. Therefore, the filling height H3 of the refractory particles 271 may be higher than the filling height H1 of the plurality of refractory particles 271 in FIG. 12.

This is only an example, and the filling height H3 of the plurality of refractory particles 271 may vary depending on the propagation speed of flame and the venting speed of an off-gas.

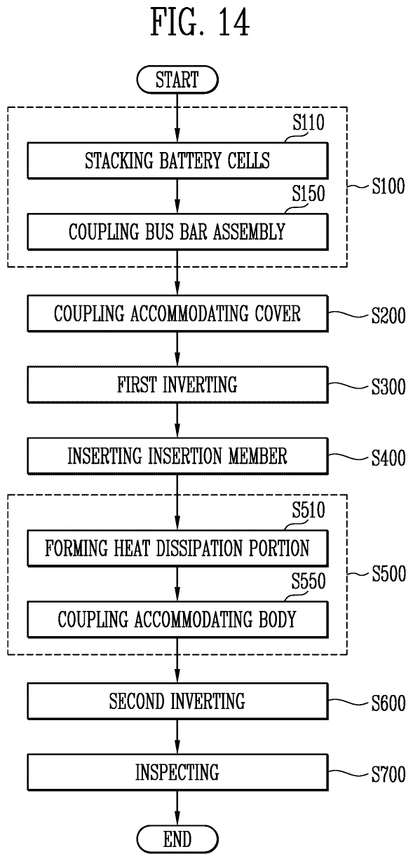

FIG. 14 shows an example of a manufacturing process of a battery assembly 200 according to the present disclosure.

Referring to FIG. 14, an assembling method of a battery assembly 200 according to the present disclosure may include stacking S110 a plurality of battery cells 110; coupling S200 an accommodating cover with the plurality of stacked battery cells 110; inserting S400 an insertion member 270 into an insertion space 288 formed between the plurality of battery cells 110 and the accommodating cover 215 along the stacking direction; and coupling S500 the accommodating body 219 with the accommodating cover 215.

The assembling method of the battery assembly 200 according to the present disclosure may include coupling S150 a bus bar assembly 150 electrically connected to the plurality of battery cells 110, after stacking S110 a plurality of battery cells 110.

The stacking S110 the plurality of battery cells 110 and the coupling S150 the bus bar assembly 150 may be collectively referred to as assembling S100 a cell stack 100.

Specifically, the assembling S100 the cell stack 100 may further include stacking (not shown) for stacking the plurality of battery cells 110 and a buffer member 117 and/or the heat-shielding member 119 positioned between the plurality of battery cells 110, after the stacking the plurality of battery cells 110.

In addition, the assembling S100 the cell stack 100 may include stacking (not shown) each end plate 212 and 213 positioned at both ends of the plurality of battery cells 110 along the stacking direction in which the plurality of battery cells 110 are stacked.

After the assembling the cell stack 100, in the assembling method of the battery assembly 200 according to the present disclosure, the coupling S200 the accommodating cover with the plurality of stacked battery cells 110 or with the cell stack 100 may be performed. The reason for assembling the accommodating cover 215 before the accommodating body 219 is to protect at least a part of the bus bar assembly 150, which is positioned on top the plurality of battery cells 110.

Thereafter, in the assembling method of the battery assembly 200 according to the present disclosure, a first inverting step S300 of inverting the accommodating cover 215 and the plurality of battery cells 110 coupled with the accommodating cover 215 may be performed. Through the first inverting step S300, the accommodating cover 215 will be positioned below the plurality of inverted battery cells 110.

The reason for inverting the battery assembly 200 being assembled is to position the insertion member 270 in the insertion space 288. Since it is difficult to insert the insertion member 270 from above due to the already assembled accommodating cover 215, the battery assembly 200 being assembled may be inverted to position the insertion member 270.

In the assembling method of the battery assembly 200 according to the present disclosure, after the first inverting step S300, inserting S400 the insertion member 270 into the insertion space 288 may be performed.

As illustrated in FIG. 9, when one end D1 of both ends of the insertion member 270 is tapered and the other end D2 is flat, in the assembling method of the battery assembly 200 according to the present disclosure, the insertion member 270 will be inserted into the insertion space 288 through the first inverting step S300 so that one end D1 of the insertion member 270 faces the accommodating cover 215. Considering that the accommodating cover 215 is inverted and positioned below, the one end D1 of the insertion member 270 will move downward.

This is because the one tapered end D1 of the insertion member 270 is easier to insert into the insertion space 288 than the other flat end D2 of the insertion member 270.

Thereafter, the assembling method of the battery assembly 200 according to the present disclosure may further include coupling S500 the accommodating body 219 with the accommodating cover 215.

Specifically, the coupling S500 the accommodating body 219 to the accommodating cover 215 may include forming S510 a heat dissipation portion 295 on the body bottom surface 2194 and coupling S550 the accommodating body 219 to the accommodating cover 215 and the cell stack 100.

The heat dissipation portion 295 may contact with the cell stack 100 when the cell stack 100 is coupled with the accommodating body 219.

After the accommodating body 219 and the accommodating cover 215 are coupled, in the assembling method of the battery assembly 200 according to the present disclosure, a second inverting step S600 of inverting the accommodating cover 215 and the accommodating body 219 may be performed.

In other words, in the battery assembly 200, which is inverted in the first inverting step S300, the accommodating cover 215 may be positioned on top of the accommodating body 219 through the second inverting step S600.

As illustrated in FIG. 9, when one end D1 of the both ends D1 and D2 of the insertion member 270 is tapered and the other end D2 is flat, in the assembling method of the battery assembly 200 according to the present disclosure, the insertion member 270 may be finally disposed through the second inverting step S600 so that the tapered end D1 of the insertion member 270 faces upward. Therefore, the insertion member 270 may be finally disposed as shown in FIG. 11.

Thereafter, in the assembling method of the battery assembly 200 according to the present disclosure, inspecting S700 the battery assembly 200 may be performed.

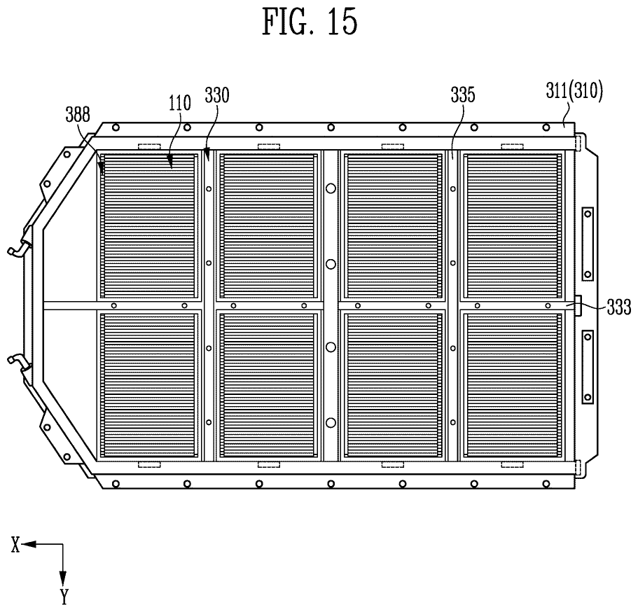

FIG. 15 shows another example of a battery assembly 300 according to the present disclosure.

The above-described battery assembly 200 is explained based on a battery assembly, but FIG. 15 shows another example of a battery assembly 300 provided in the form of a battery pack. In other words the battery assembly 200 may be in the form of a cell-to-pack (CTP) structure in which a plurality of battery cells 110 are directly accommodated in the form of a pack, omitting a battery assembly.

The battery assembly 300 may include: a plurality of battery cells 110 stacked and arranged in a preset stacking direction; an accommodating case 310 for accommodating the plurality of battery cells; an insertion space 388 formed between the plurality of battery cells 110 the accommodating case along the stacking direction; and an insertion member (not shown) positioned in the insertion space.

The insertion member 270 (see FIG. 6A) may include refractory particles 271 (see FIG. 6C) and a binder 273 (FIG. 6C) that binds the refractory particles 271 to form a preset three-dimensional shape. In FIG. 13, the above-described insertion member 270 is omitted for explanation of the accommodating case 210.

The accommodating case 310 may include an accommodating body 311 accommodating the plurality of battery cells 110 and an accommodating cover (not shown) coupled with the accommodating body 311. In addition, the accommodating case 310 may further include a partition 330 partitioning the insertion space 388.

The partition 330 may further include a first frame 333 and a second frame 335 that partition the plurality of battery cells 110 horizontally and vertically, respectively. The first frame 333 and the second frame 335 are not only to prevent deformation of the accommodating body 311 but also to support and distinguish the plurality of battery cells 110.

The present disclosure may be modified and implemented in various forms, and its scope is not limited to the embodiments described above. Therefore, if a modified embodiment includes components of the present disclosure, it should be regarded as falling within the scope of the rights of the present disclosure.

What is claimed is:

1. A battery assembly comprising:
a plurality of battery cells arranged in a preset stacking direction;
an accommodating case accommodating the plurality of battery cells;
an insertion space defined between the plurality of battery cells and the accommodating case along the stacking direction; and
an insertion member positioned in the insertion space,
wherein the insertion member includes refractory particles; and a binder that binds the refractory particles to form a preset three-dimensional shape.

2. The battery assembly according to claim 1, wherein the binder melts at a preset temperature or higher.

3. The battery assembly according to claim 1, wherein the insertion member forms a cylindrical shape as the refractory particles are bound by the binder.

4. The battery assembly according to claim 2, wherein at least one end of the insertion member of the cylindrical shape is tapered.

5. The battery assembly according to claim 4, wherein a tapered end among the two ends of the insertion member is disposed to face an upper portion of the accommodating case.

6. The battery assembly according to claim 2, wherein each area adjacent to two ends of the insertion member of the cylindrical shape has the same shape.

7. The battery assembly according to claim 2, wherein the diameter of the insertion member of the cylindrical shape is smaller than the height of the insertion member of the cylindrical shape.

8. The battery assembly according to claim 2, wherein the diameter of the insertion member of the cylindrical shape is smaller than or equal to the thickness of any one battery cell among the plurality of battery cells.

9. The battery assembly according to claim 2, wherein, when the binder melts the temperature or higher, the volume occupied by the refractory particles in the insertion space is 50% or more of the volume of the insertion space.

10. The battery assembly according to claim 1, wherein the melting point of the refractory particles is higher than the ignition point of the plurality of battery cells.

11. The battery assembly according to claim 1, wherein the binder begins to melt at 200° C. (degree Celsius).

12. The battery assembly according to claim 1, wherein the refractory particles include a porous material, and the porosity of the porous material is 20 percent (%) or more and 30 percent (%) or less.

13. The battery assembly according to claim 1, wherein the refractory particles include silicon dioxide.

14. The battery assembly according to claim 1, further comprising a heat-shielding member positioned between the plurality of battery cells to face adjacent battery cells.

15. The battery assembly according to claim 1, further comprising a bus bar electrically connected to the plurality of battery cells, wherein the insertion space is positioned between the bus bar and the plurality of battery cells.

16. The battery assembly according to claim 1, wherein the accommodating case further includes: an accommodating body that includes an open upper surface and accommodates the plurality of battery cells through the open upper surface; and an accommodating cover that is coupled with the accommodating body and that covers the open upper surface.

17. An assembling method of a battery assembly including: a plurality of battery cells each including a lead tab portion protruding outward and stacked and arranged in a preset stacking direction; an accommodating body including an opening at an upper portion; and an accommodating cover that is coupled with the accommodating body and that covers the open upper surface,
the assembling method comprising:
stacking the plurality of battery cells;
coupling the accommodating cover with the plurality of stacked battery cells;
inserting an insertion member into an insertion space formed between the plurality of battery cells and the accommodating cover along the stacking direction; and
coupling the accommodating body with the accommodating cover.

18. The assembling method according to claim 17, further comprising forming a heat dissipation portion on a body bottom surface that forms a bottom surface of the accommodating body, prior to the coupling the accommodating body with the accommodating cover.

19. The assembling method according to claim 17, further comprising a first inverting step of inverting the accommodating cover and the plurality of battery cells coupled with the accommodating cover, between the coupling the accommodating cover with the plurality of stacked battery cells and the inserting the insertion member into the insertion space.

20. The assembling method according to claim 19, further comprising a second inverting step of inverting the accommodating cover and the accommodating body so that the accommodating body is positioned above the accommodating body, after the coupling the accommodating body with the accommodating cover.
